(19) United States
(12) Patent Application Publication
(10) Pub. No.: US 2019/0057380 A1
(43) Pub. Date: Feb. 21, 2019

(54) Internet of things (IoT) system and method

(71) Applicant: MASTERCARD ASIA/PACIFIC PTE. LTD., Singapore (SG)

(72) Inventors: John Florinis, Markham (CA); Syam Sasidharan Nair, Singapore (SG); Chee Leong Liew, Singapore (SG); Holger Kunkat, Neumuenster (DE)

(73) Assignee: MASTERCARD ASIA/PACIFIC PTE. LTD., Singapore (SG)

(21) Appl. No.: 15/998,467

(22) Filed: Aug. 15, 2018

(30) Foreign Application Priority Data
Aug. 15, 2017 (SG) 10201706675X

(51) Int. Cl. G06Q 20/36; G06Q 20/32; G06Q 20/40

(52) U.S. Cl. CPC G06Q 20/3674; G06Q 20/4014; G06Q 20/405; G06Q 20/3223

(57) ABSTRACT

An Internet of Things (IoT) system, the system including: (a) an IoT platform in communication with a device via a communications network; and, (b) a payment service provider, wherein, in use: (i) the IoT platform: (1) receives a transaction message from the device, the transaction message being indicative of: (a) a device identifier; and, (b) transaction details indicative of a transaction to be performed; (2) uses the device identifier to retrieve transaction data indicative of: (a) a user identifier; and, (b) transaction rules; (3) generates a payment request using the transaction details and transaction rules, the payment request being indicative of: (a) the user identifier; (b) a merchant identifier; and, (c) transaction information at least partially based on the transaction details; and, (4) provides the payment request to the payment service provider; and, (ii) the payment service provider: (1) receives the payment request; (2) determines a user account at least in part using the user identifier, the user account associated with user account information; (3) determines payment details using the merchant identifier and the transaction information; and, (4) causes the transaction to be processed using the user account information and the payment details to thereby enable the merchant to be paid in accordance with the payment details.

### CROSS REFERENCE TO RELATED APPLICATIONS

This application claims priority to Singapore Application Serial No. 10201706675X, filed Aug. 15, 2017, which is incorporated herein by reference in its entirety

### BACKGROUND OF THE INVENTION

The present invention relates to an Internet of Things (IoT) system and method, and in one example to a system and method enabling a network connected IoT device to initiate a payment transaction with a goods/service provider through an IoT platform.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

The Internet of Things (IoT) is the network of physical devices, vehicles, buildings and any other items (things) embedded with electronics, software, sensors, actuators, and network connectivity that enable these objects to collect and exchange data.

The IoT ecosystem consists of devices integrated in a plethora of applications including retail, smart homes and cities, utilities (smart grid), health, agriculture, connected vehicles etc. The ecosystem is underpinned by enabling technology including software for IoT platforms, security, infrastructure and payments.

The evolution of IoT brings with it new payment scenarios which have previously not been considered. Existing payment systems are made for supporting known payment scenarios including human to human payment (H2H) such as cash payment and human to machine payment (H2M) such as in-store payment at a terminal by a customer swiping, inserting or tapping a payment card or mobile wallet. In an e-commerce environment, a customer typically enters payment details in a merchant website or app (computer or mobile) for purchase of goods.

The connectivity of devices enabled by IoT introduces the possibility of new payment scenarios such as payment executed from one machine to another (M2M) with or without any human interaction. For example, devices (or things) may initiate payment without any interventions based on usage of the device or service provided by the device.

However, it is to be appreciated that the environment in which IoT devices operate lack security and therefore unlike other payment environments, devices or things are exposed to vulnerabilities. It would therefore be advantageous to mitigate this security risk by ensuring that whilst a user's payment credentials are paired or linked to the device, any payment data generated during a transaction is not shared with the device.

At present, IoT platforms (such as Microsoft Azure IoT and IBM Watson) have no in-built payment mechanism available and platform providers have to perform multiple integrations with external payment providers. It would therefore be advantageous to integrate a payment mechanism with an IoT platform in order to support various M2M payments in the IoT environment.

It is against this background, and the problems and difficulties associated therewith, that the present invention has been developed.

### SUMMARY OF THE PRESENT INVENTION

In a broad form, the present invention seeks to provide a system for managing transactions over a communications network, the system including:
a) a connected device management platform in communication with a device via a communications network; and,
b) a payment service provider, wherein, in use:
   i) the connected device management platform:
      (1) receives a transaction message from the device, the transaction message being indicative of:
         (a) a device identifier; and,
         (b) transaction details indicative of a transaction to be performed;
      (2) uses the device identifier to retrieve transaction data indicative of:
         (a) a user identifier; and,
         (b) transaction rules;
      (3) generates a payment request using the transaction details and transaction rules, the payment request being indicative of:
         (a) the user identifier; and,
         (b) a merchant identifier;
         (c) transaction information at least partially based on the transaction details; and,
      (4) provides the payment request to the payment service provider; and,
   ii) the payment service provider:
      (1) receives the payment request;
      (2) determines a user account at least in part using the user identifier, the user account associated with user account information;
      (3) determines payment details using the merchant identifier and the transaction information; and,
      (4) causes the transaction to be processed using the user account information and the payment details to thereby enable the merchant to be paid in accordance with the payment details.

In another broad form, the present invention seeks to provide a method for use in a system including a connected device management platform in communication with a device via a communications network and a payment service provider, the method including:
a) in the connected device management platform:
   i) receiving a transaction message from the device, the transaction message being indicative of:
      (a) a device identifier; and,
      (b) transaction details indicative of a transaction to be performed;
   ii) using the device identifier to retrieve transaction data indicative of:
      (a) a user identifier; and,
      (b) transaction rules;
   iii) generating a payment request using the transaction details and transaction rules, the payment request being indicative of:
      (a) a user identifier;
      (b) a merchant identifier;
      (c) transaction information at least partially based on the transaction details; and,
   iv) providing the payment request to the payment service provider; and,
b) in the payment service provider:
   i) receiving the payment request;
   ii) determining a user account at least in part using the user identifier, the user account associated with user account information;
   iii) determining payment details using the merchant identifier and the transaction information; and,
   iv) causing the transaction to be processed using the user account information and the payment details to thereby enable the merchant to be paid in accordance with the payment details.

In a further broad form, the present invention seeks to provide a system including a connected device management platform in communication with a device via a communications network, wherein the connected device management platform:
a) receives a transaction message from the device, the transaction message being indicative of:
   i) a device identifier; and,
   ii) transaction details indicative of a transaction to be performed;
b) uses the device identifier to retrieve transaction data indicative of:
   i) a user identifier; and,
   ii) transaction rules;
c) generates a payment request using the transaction details and transaction rules, the payment request being indicative of:
   i) a user identifier;
   ii) a merchant identifier; and,
   iii) transaction information at least partially based on the transaction details;
d) provides the payment request to the payment service provider;
e) receives a transaction completion message in response to the payment service provider successfully processing the payment request; and,
f) provides an indication that the transaction has been completed to the device.

In yet a further broad form, the present invention seeks to provide a system including a payment service provider that:
a) receives a payment request from a connected device management platform indicative of a transaction initiated by a device in communication with the connected device management platform, the payment request based at least in part on at least one of:
   i) a user identifier;
   ii) a merchant identifier; and,
   iii) transaction information at least partially indicative of a transaction to be performed;
b) determines a user account at least in part using the user identifier, the user account associated with user account information;
c) determines payment details using the merchant identifier and the transaction information; and,
d) causes the transaction to be processed using the user account information and the payment details to thereby enable the merchant to be paid in accordance with the payment details.

It will be appreciated that the broad forms of the invention and their respective features can be used in conjunction, interchangeably and/or independently, and reference to separate broad forms is not intended to be limiting.

### BRIEF DESCRIPTION OF THE DRAWINGS

A non-limiting example of the present invention will now be described with reference to the accompanying drawings, in which:—

FIG. 1 is a flow chart of an example of a method of facilitating a payment transaction in an Internet of Things (IoT) system;

FIG. 2 is a schematic diagram of an example of an IoT payment transaction system;

FIG. 3 is a schematic diagram of an example of an networked connected IoT device;

FIG. 4 is a schematic diagram of an example of an IoT platform;

FIG. 5 is a schematic diagram of an example of a payment service provider;

FIG. 6 is a schematic diagram of an example of a digital wallet provider;

FIGS. 7A and 7B provide a flowchart of an example of a digital wallet account registration process through the IoT platform;

FIG. 8 provides an example of a graphical user interface (GUI) for use in a digital wallet registration process from an IoT platform;

FIG. 9 provides a further specific example of operation flow in a digital wallet registration process for an IoT platform;

FIGS. 10A to 10B provide a flowchart of an example of a specific method of facilitating a payment transaction in an IoT system between a device and a merchant;

FIG. 11 is a schematic diagram of an example of a system architecture enabling an IoT device to initiate a payment through an IoT platform;

FIG. 12 provides a further specific example of process flow in an IoT payment system; and,

FIG. 13 is an example of a commerce use case in an IoT system where a smart health monitor initiates an order for a medicine refill through an IoT platform.

### DETAILED DESCRIPTION OF THE PREFERRED EMBODIMENTS

There is provided a method of facilitating a payment transaction in an Internet of Things (IoT) system that provides a mechanism to enable a network connected IoT device to initiate a payment for goods/services through an IoT platform without necessarily requiring any human intervention to process the transaction. It should be noted that the IoT platform can relate to a platform for managing/controlling devices connected to the platform. The devices can include IoT devices.

The IoT platform utilises a transaction message from the IoT device to retrieve transaction data and carries out a transaction upon requisite authorisation being carried out. In this way, it is possible for the IoT platform to facilitate machine to machine (M2M) payment with relative ease. The ability for user configured IoT devices to perform payments on behalf of their users/owners/service providers provides a significant time and potential cost saving to these entities. Instead of receiving periodic bills from merchants for goods/services consumed, for example electricity bills, which require administration to monitor deadlines and then subsequent user initiated payments, devices are able to initiate these payments by themselves. This improves the user experience and reduces their administrative burden.

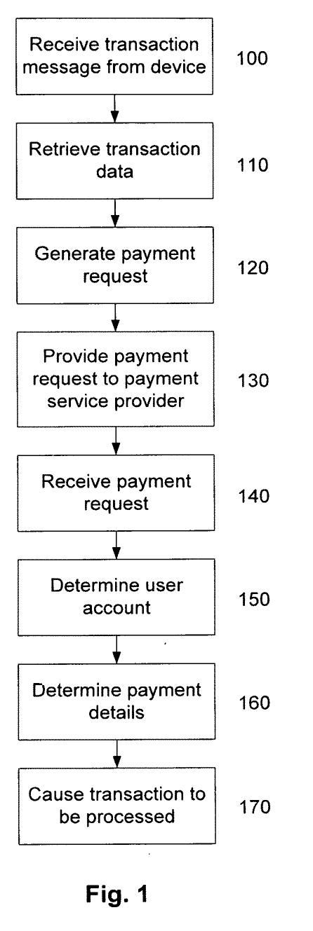

An example of a method of facilitating a payment transaction in an IoT system shall now be described with reference to FIG. 1.

For the purpose of illustration, it is assumed that the process is performed at least in part using one or more electronic processing devices forming part of one or more processing systems such as a cloud based IoT platform and a payment service provider. The IoT platform is in communication with the payment service provider and further connected to one or more network enabled IoT devices, such as smart appliances, vehicles, wearable devices, or the like, via a network architecture, as will be described in more detail below.

It is therefore to be understood that for the purpose of this example, the IoT system includes at least an IoT platform in communication with a device via a communications network and a payment service provider.

In this example, at step 100, the IoT platform receives a transaction message from the device, the transaction message being indicative of a device identifier and transaction details indicative of a transaction to be performed. The device identifier may be in the form of a unique device identity number or label and the like which enables the IoT platform to look up a user profile to which the device is linked. In some examples, user identity information may be sent in the transaction message from the device. The transaction details received from the device are typically indicative of at least one of a payment amount, usage information, and, order information. For example, a smart fridge may determine that the user is out of milk and then place an order for a carton of milk. A smart washing machine may detect a fault and order a service. A smart vehicle may initiate payment of a parking fee and a utility device may request payment for a quantum of electricity consumed. Whilst the transaction message from the device may include a payment amount, typically this will be determined later by the IoT platform or payment service provider.

At step 110, the IoT platform uses the device identifier to retrieve transaction data indicative of a user identifier and transaction rules. The user identifier may be in the form of a unique identity or customer reference number or may be the user's name or other alias. The transaction rules may define at least one of the type of goods or service that the device is permitted to purchase, a frequency of orders that that the device is permitted to make, quantities of goods that the device is permitted to order, pre-approved merchants that the device is permitted to use to perform the transaction, and whether user authentication is required. In this way, the IoT platform may selectively authenticate the device request to ensure that the transaction being requested is permitted in accordance with user defined rules governing transactions that the device is allowed to initiate.

At step 120, the IoT platform generates a payment request using the transaction details and transaction rules, the payment request being indicative of the user identifier, a merchant identifier, and transaction information at least partially based on the transaction details. In this step, the IoT platform typically determines the merchant that is to provide the goods/service or that has already provided the goods/service for the device. Optionally, the IoT platform may also determine the payment amount for the goods/service from the merchant so that this information is included in the payment request, or this may be determined later by the payment service provider using the merchant identifier.

Accordingly, the IoT platform then provides the payment request to the payment service provider at step 130. At step 140, the payment request is received by the payment service provider.

At step 150, the payment service provider determines a user account at least in part using the user identifier, the user account associated with user account information. In this example, it is assumed that the user has an existing account or payment instrument that has been paired to the IoT platform and associated with the device initiating the transaction. The user account information will typically include the user's default credit/debit account number, shipping address, name and the like.

The payment service provider then determines payment details using the merchant identifier and the transaction information. Typically, the payment details will include at least the payment amount, merchant account information and information pertaining to whether the merchant has an existing payment provider or acquirer through which the transaction should be processed.

Finally, at step 170, the payment service provider causes the transaction to be processed using the user account information and the payment details to thereby enable the merchant to be paid in accordance with the payment details.

Accordingly, it will be appreciated that the above described process provides a mechanism to enable a network connected IoT device to initiate a payment for goods/services through an IoT platform without necessarily requiring any human intervention to process the transaction. In this way, it is possible for the IoT platform to facilitate machine to machine (M2M) payment with relative ease. The ability for user configured IoT devices to perform payments on behalf of their users/owners/service providers provides a significant time and potential cost saving to these entities. Instead of receiving periodic bills from merchants for goods/services consumed, for example electricity bills, which require administration to monitor deadlines and then subsequent user initiated payments, devices are able to initiate these payments by themselves. This improves the user experience and reduces their administrative burden.

Furthermore, the method is able to execute payments in a secure manner by ensuring that no sensitive payment data is exposed to the devices or IoT platform. Only non-payment card industry (PCI) data is passed between the device, and IoT platform. PCI data is only ever passed to the payment service provider. This enables secure payments to be performed in an IoT environment in which devices and the like may have security vulnerabilities.

A number of further features shall now be described.

Typically, the user account is a digital wallet account that is paired to the IoT platform. The use of a secure digital wallet that is integrated with the IoT platform helps to mitigate the security risk by keeping the device out of payment data. As will be described in further detail below, a user is able to register for a digital wallet through the IoT platform and then assign payment credentials to each device that is setup on the platform and able to initiate payments. The use of a digital wallet to facilitate payments in an IoT environment is further advantageous as digital wallets are able to support all types of cards and schemes, provide a secure, simple and fast payment experience from any device and have an application programming interface (API) driven approach which makes them flexible to be able to design the payment experience.

With a digital wallet account, a user is able to add various payment instruments (such as credit and debit cards) to their wallet. A payment instrument may then be assigned to a particular IoT device and becomes the default instrument to perform payments. Accordingly, the user account information associated with the user account is indicative of at least one payment instrument that has been assigned to the device through the IoT platform.

As previously mentioned, the transaction details received by the IoT platform in the transaction message from the device are indicative of at least one of a payment amount, usage information and order information. The payment amount may be known by the device for example if the payment being made is a regular or periodic payment for a known amount (for example a fixed plan with monthly payments or the like). Otherwise, more often the payment amount is not known by the device when the transaction message is sent. Instead, the device simply provides an indication for the goods/service requested, e.g. quantity of goods, service required, commodity consumed etc.

Each device paired to the IoT platform may have pre-defined transaction rules associate therewith so that the platform can ensure that the transaction request being made by the device is an allowable request. The transaction rules may define at least one of: the type of goods or service that the device is permitted to purchase, a frequency of orders that that the device is permitted to make, quantities of goods that the device is permitted to order, pre-approved merchants that the device is permitted to use to perform the transaction, and whether user authentication is required. In use, the IoT platform may compare the transaction details received from the device with the transaction rules for the device to thereby authenticate the transaction message prior to generating the payment request. This type of check may be used to enhance security of the system and ensure for example that if security of the device has been compromised, rogue orders or transaction requests will be declined.

As discussed above, the payment details determined by the payment service provider are indicative of at least one of: a payment amount, merchant account information, merchant acquirer information, and, merchant payment provider information. Typically, the payment service provider will obtain this information from the merchant who will also be registered with the payment service provider so that payments can be received. The merchant may or may not have their own payment provider and acquirer and so the payment service provider integrated with the IoT platform may perform the payment processing for them or alternatively may send the payment details to the merchant's acquirer or own payment provider so that the transaction can be performed.

In one example, in response to receiving the transaction message from the device, the IoT platform generates a transaction authorization request, and sends the transaction authorization request to a user device, the user device being responsive to the transaction authorization request to obtain authorization from a user, and selectively provide an authorization response to the IoT platform. This is an optional step that may be configured if the user would still like to authorisation each device transaction request prior to payment being processed. After the IoT platform receives the authorisation response from the user device, it at least one of proceeds to generate the payment request, and, notifies the device that the transaction has been declined. This user authorisation step, although not essential, may be useful in such a system to develop user trust in the M2M payments being performed.

As previously mentioned, the preferred user account is a digital wallet account and as such the IoT system typically further includes a digital wallet provider that is integrated with the IoT platform along with the payment service provider.

In an example of a payment scenario, the digital wallet provider typically receives a request from the payment service provider to provide pre-transaction data associated with the user's digital wallet account, the request including a wallet identifier token which identifies the user's digital wallet account that is paired to the IoT platform. The wallet provider then uses the wallet identifier token to retrieve the pre-transaction data, and, provides the pre-transaction data to the payment service provider. The wallet identifier token is a one time use token initially created when the user pairs their digital wallet account with the IoT platform. The pre-transaction data may include information such as the last three digits of the user's payment card, shipping id, reward card information and the like.

After receiving the pre-transaction data from the digital wallet provider, the payment service provider is typically then responsive to request a payment payload from the digital wallet provider, the digital wallet provider being responsive to the payment payload request to retrieve the payment payload, generate a new wallet identifier token, and, send the payment payload and new wallet identifier token to the payment service provider. As will be appreciated by those skilled in the art, the payment payload is typically indicative of at least one of user account information, a shipping address, user data, a payment amount, a payment currency, a merchant identifier and, order information. This sensitive payment data is not exposed to the IoT platform and is passed securely between the payment service provider and digital wallet provider.

The payment service provider receives the payment payload from the digital wallet provider, and, sends the payment payload to one of a merchant acquirer, and, a merchant payment provider. Alternatively, if the merchant doesn't have their own acquirer or payment provider then the payment service provider integrated with the IoT platform can process the transaction on behalf of the merchant.

Accordingly, the payment is processed in accordance with the payment payload and after successful payment authorisation, the IoT platform receives a transaction completion response from the merchant acquirer or merchant payment provider. If the payment service provider integrated with the IoT platform processes the transaction then this provider may send the authorisation response back to the IoT platform.

Typically, in response to receiving the transaction completion response, the IoT platform sends payment completion information to the device. This communication ends the transaction and notifies the device that payment has been executed for the transaction request. The payment status and details of the completed transaction may then be stored by the payment service provider and digital wallet provider.

It is to be appreciated that in this description, the IoT platform, payment service provider and digital wallet provider each consist of one or more electronic processing devices that are configured to the perform the necessary functions as will be described in further detail below.

In another broad form, there is provided a method for use in an Internet of Things (IoT) system including an IoT platform in communication with a device via a communications network and a payment service provider, the method including: in the IoT platform: receiving a transaction message from the device, the transaction message being indicative of: a device identifier; and, transaction details indicative of a transaction to be performed; using the device identifier to retrieve transaction data indicative of: a user identifier; and, transaction rules; generating a payment request using the transaction details and transaction rules, the payment request being indicative of: the user identifier; a merchant identifier; and, transaction information at least partially based on the transaction details; and, providing the payment request to the payment service provider. The method further includes in the payment service provider: receiving the payment request; determining a user account at least in part using the user identifier, the user account associated with user account information; determining payment details using the merchant identifier and the transaction information; and, causing the transaction to be processed using the user account information and the payment details to thereby enable the merchant to be paid in accordance with the payment details.

In a further broad form, there is provided an Internet of Things (IoT) system, the system including an IoT platform in communication with a device via a communications network, wherein the IoT platform: receives a transaction message from the device, the transaction message being indicative of: a device identifier; and, transaction details indicative of a transaction to be performed; uses the device identifier to retrieve transaction data indicative of: a user identifier; and, transaction rules; generates a payment request using the transaction details and transaction rules, the payment request being indicative of: a user identifier; a merchant identifier; and, transaction information at least partially based on the transaction details; provides the payment request to the payment service provider; receives a transaction completion message in response to the payment service provider successfully processing the payment request; and, provides an indication that the transaction has been completed to the device.

In still a further broad form, there is provided an Internet of Things (IoT) system, the system including a payment service provider that: receives a payment request from an IoT platform indicative of a transaction initiated by a device in communication with the IoT platform, the payment request based at least in part on at least one of: a user identifier; a merchant identifier; and, transaction information at least partially indicative of a transaction to be performed; determines a user account at least in part using the user identifier, the user account associated with user account information; determines payment details using the merchant identifier and the transaction information; and, causes the transaction to be processed using the user account information and the payment details to thereby enable the merchant to be paid in accordance with the payment details.

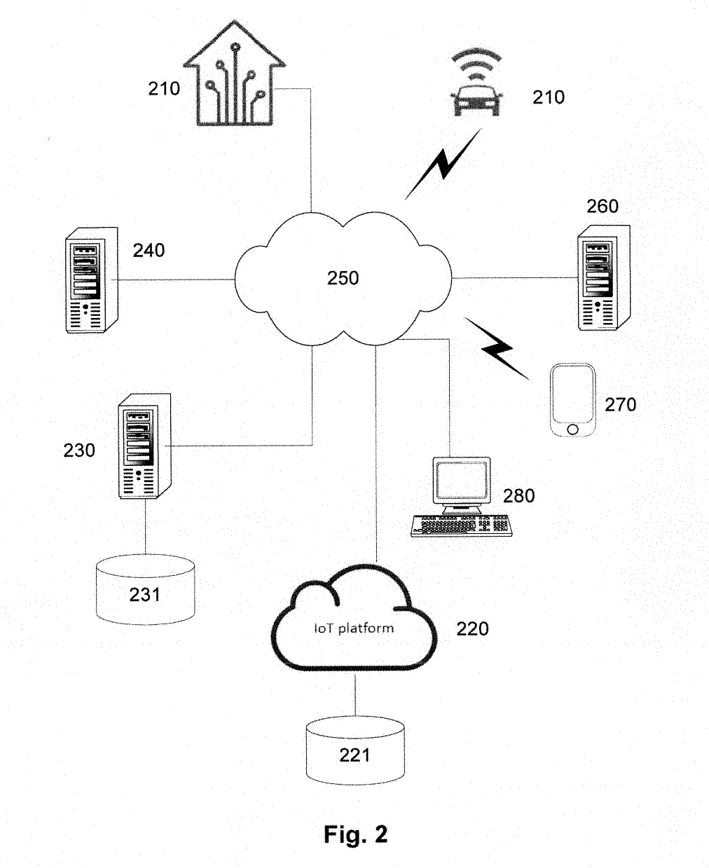

In one example, the process is performed by one or more processing systems operating as part of a distributed architecture, an example of which will now be described with reference to FIG. 2.

In this example, a number of IoT devices (or “things”) 210 are provided coupled to an IoT platform 220 via one or more communications networks 250, such as the Internet, and/or a number of local area networks (LANs). The IoT platform 220 is further coupled to a payment service provider 230 and a digital wallet provider 270 and may optionally also communicate with a user device 240 and merchant processing system 280. The payment service provider 230 may optionally communicate with a merchant acquirer or payment provider 260 via the one or more communication networks 250.

It is to be appreciated that the network configuration shown is for the purpose of example only and that the various entities shown in the system of FIG. 2 can communicate via any appropriate mechanism, such as via wired or wireless connections, including, but not limited to mobile networks, private networks, such as an 802.11 networks, the Internet, LANs, WANs, or the like, as well as via direct or point-to-point connections, such as Bluetooth, or the like.

In use, processing systems associated with each entity are adapted to perform various data processing tasks forming part of a transaction process, and the particular functionality will vary depending on the particular requirements. For example, the IoT platform can be adapted to receive transaction messages from the device, retrieve transaction data, perform device authentication, process user authentication, generate payment requests and send payment requests to the payment service provider. The payment service provider can be adapted to receive payment requests, determine user account information, determine payment details, perform payments, or cause further payment systems, such as servers of financial institutions, payment gateways or the like associated with the merchant, to perform payments, as will be appreciated by persons skilled in the art.

Whilst the processing systems 210, 220, 230, 240, 260, 270, 280 are shown as single entities, it will be appreciated they could include a number of processing systems distributed over a number of geographically separate locations, for example as part of a cloud based environment. Thus, the above described arrangements are not essential and other suitable configurations could be used.

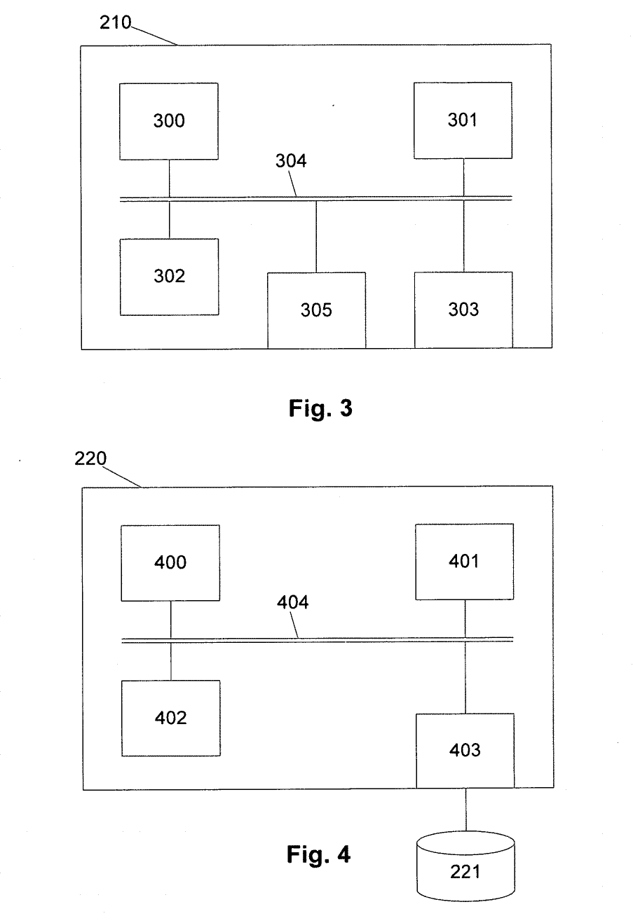

An example of a suitable processing system for a network connected IoT device 210 is shown in FIG. 3. In this example, the IoT device 210 includes at least one microprocessor 300, a memory 301, an optional input/output device 302, such as a keyboard and/or display, one or more sensors 305 and an external interface 303, interconnected via a bus 304 as shown. In this example the external interface 303 can be utilised for connecting the IoT device 210 to peripheral devices, such as the communications networks 250, storage devices, or the like. Although a single external interface 303 is shown, this is for the purpose of example only, and in practice multiple interfaces using various methods (e.g. Ethernet, serial, USB, wireless or the like) may be provided.

In use, the microprocessor 300 executes instructions in the form of applications software stored in the memory 301 to allow the required processes to be performed. The applications software may include one or more software modules, and may be executed in a suitable execution environment, such as an operating system environment, or the like. In one example, the sensors 305 may be used to determine that the IoT device 210 requires a quantity of goods/service to be ordered. For example, in the case of a smart fridge, the fridge may have sensors which detect when the fridge is out of milk or bread. The microprocessor 300 receives the sensor data from sensors 305 and processes the data to determine the goods/service required. This microprocessor 300 then generates a transaction message which is sent to the IoT platform 220 to initiate a payment.

Accordingly, it will be appreciated that the processing system for the IoT device 210 may be formed from any suitable processing system, such as a suitably programmed computer system, web server, network server, or the like. In one particular example, the processing system of the IoT device 210 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

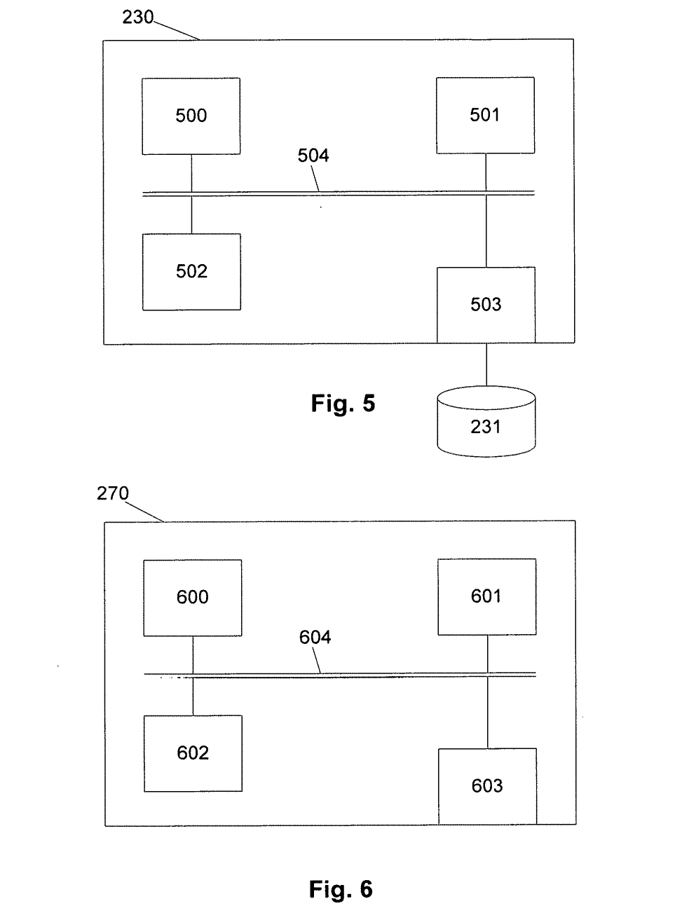

An example of a suitable processing system for the IoT platform 220 is shown in FIG. 4. In this example, the processing system includes at least one microprocessor 400, a memory 401, an input/output device 402, such as a keyboard and/or display, an external interface 403, interconnected via a bus 404 as shown. In this example the external interface 403 can be utilised for connecting the IoT platform 220 to peripheral devices, such as the communications networks 250, databases 221, other storage devices, or the like. Although a single external interface 403 is shown, this is for the purpose of example only, and in practice multiple interfaces using various methods (eg. Ethernet, serial, USB, wireless or the like) may be provided.

In use, the microprocessor 400 executes instructions in the form of applications software stored in the memory 401 to allow the required processes to be performed. The applications software may include one or more software modules, and may be executed in a suitable execution environment, such as an operating system environment, or the like.

Accordingly, it will be appreciated that the IoT platform 220 may be formed from any suitable processing system, such as a suitably programmed computer system, web server, network server, or the like. In one particular example, the processing system of the IoT platform 220 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

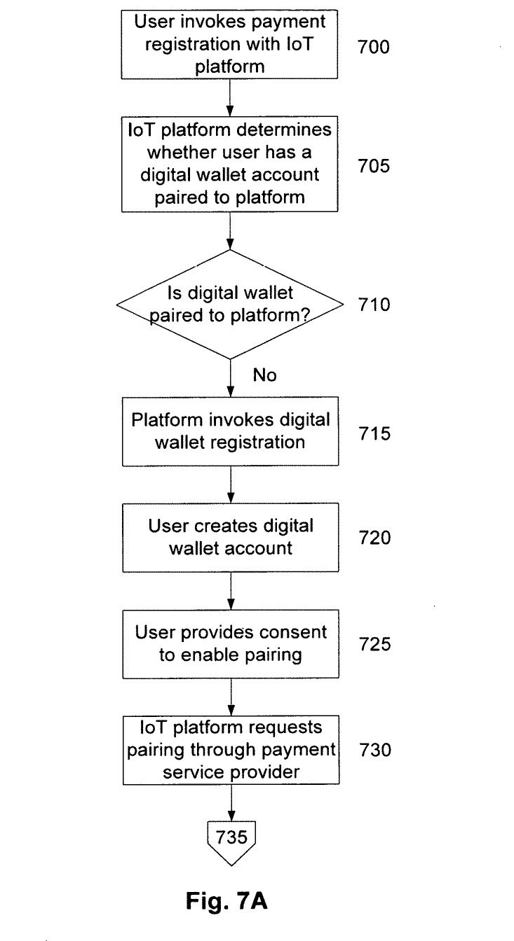

An example of a suitable processing system for the payment service provider 230 is shown in FIG. 5. In this example, the processing system includes at least one microprocessor 500, a memory 501, an input/output device 502, such as a keyboard and/or display, an external interface 503, interconnected via a bus 504 as shown. In this example the external interface 503 can be utilised for connecting the payment service provider 230 to peripheral devices, such as the communications networks 250, databases 231, other storage devices, or the like. Although a single external interface 503 is shown, this is for the purpose of example only, and in practice multiple interfaces using various methods (eg. Ethernet, serial, USB, wireless or the like) may be provided.

In use, the microprocessor 500 executes instructions in the form of applications software stored in the memory 501 to allow the required processes to be performed. The applications software may include one or more software modules, and may be executed in a suitable execution environment, such as an operating system environment, or the like.

Accordingly, it will be appreciated that the payment service provider 230 may be formed from any suitable processing system, such as a suitably programmed computer system, web server, network server, or the like. In one particular example, the processing system of the payment service provider 230 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

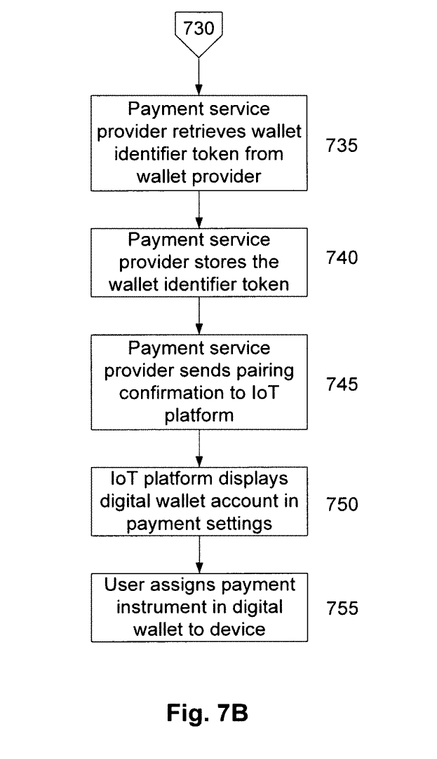

An example of a suitable processing system for the digital wallet provider 270 is shown in FIG. 6. In this example, the processing system includes at least one microprocessor 600, a memory 601, an input/output device 602, such as a keyboard and/or display, an external interface 603, interconnected via a bus 604 as shown. In this example the external interface 603 can be utilised for connecting the digital wallet provider 270 to peripheral devices, such as the communications networks 250, other storage devices, or the like. Although a single external interface 603 is shown, this is for the purpose of example only, and in practice multiple interfaces using various methods (eg. Ethernet, serial, USB, wireless or the like) may be provided.

In use, the microprocessor 600 executes instructions in the form of applications software stored in the memory 601 to allow the required processes to be performed. The applications software may include one or more software modules, and may be executed in a suitable execution environment, such as an operating system environment, or the like.

Accordingly, it will be appreciated that the digital wallet provider 270 may be formed from any suitable processing system, such as a suitably programmed computer system, web server, network server, or the like. In one particular example, the processing system 270 is a standard processing system such as an Intel Architecture based processing system, which executes software applications stored on non-volatile (e.g., hard disk) storage, although this is not essential. However, it will also be understood that the processing system could be any electronic processing device such as a microprocessor, microchip processor, logic gate configuration, firmware optionally associated with implementing logic such as an FPGA (Field Programmable Gate Array), or any other electronic device, system or arrangement.

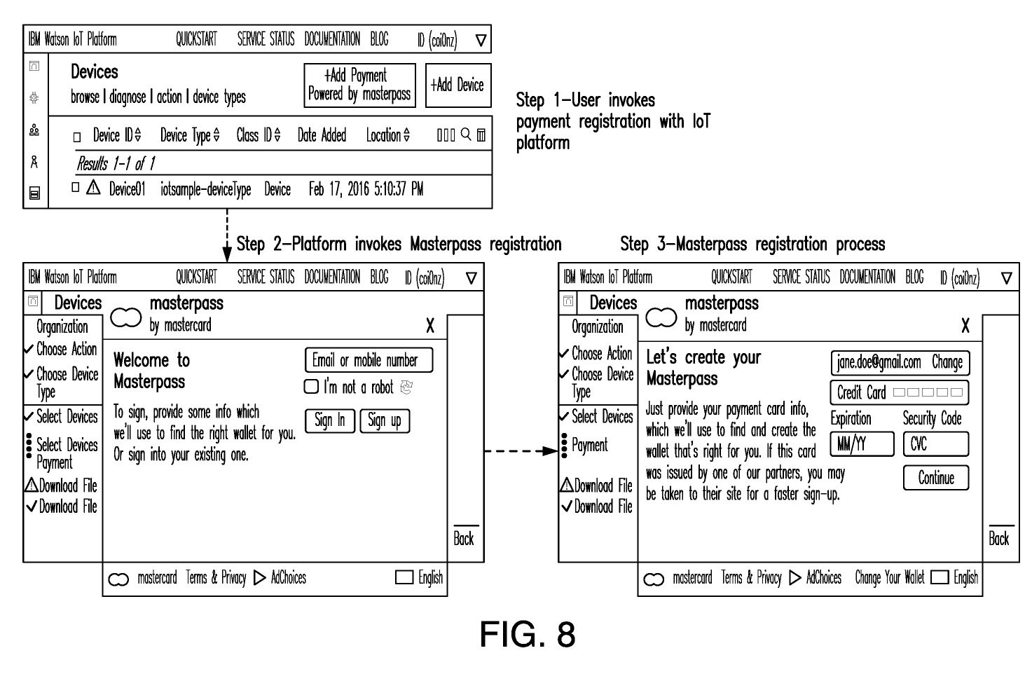

A specific example of a digital wallet account registration process shall now be described with reference to FIGS. 7A and 7B.

In this example, at step 700, the user who is logged into their account with the IoT platform 220, invokes payment registration with the IoT platform 220. This may be achieved for example by clicking on an ‘Add payment’ tab displayed within the IoT platform web portal or mobile application. In response, at step 705 the IoT platform 220 determines whether the user has a digital wallet account that is already paired to the platform 220. If at step 710, it is determined that there is no existing digital wallet account paired to the IoT platform 710 then at step 715, the IoT platform 220 invokes a digital wallet registration process provided by the digital wallet provider 270. For example, a digital wallet registration page may be displayed to the user through the IoT platform 220 prompting them to create an account. At step 720, the user creates a new digital wallet account by adding details of one or more payment instruments such as credit or debit card as well as shipping information and other user data required by the wallet provider 270. The user then provides consent for the digital wallet account to be paired to the IoT platform 220 at step 725.

The IoT platform 220 then requests pairing through the payment service provider 230 at step 730, the payment service provider 230 responsive to the pairing request to retrieve a wallet identifier token from the wallet provider 270 at step 735. At step 740, the wallet provider 270 provides the wallet identifier token to the payment service provider 230 which stores the wallet identifier token and sends pairing confirmation to the IoT platform 220 at step 745. It is to be appreciated that the wallet identifier token is a one-time use token which is passed to the payment service provider 230 from the wallet provider 270 and that the wallet identifier token is indicative of the pairing between the digital wallet account and the IoT platform 220.

At step 750, after pairing is completed, the IoT platform 220 displays the new digital wallet account in the payment settings of the IoT platform 220. The user is then able to use the digital wallet account to assign a payment instrument to each device 210 configured for use with the IoT platform 220. When the device 210 initiates a payment transaction through the IoT platform 220, the user's digital wallet paired to the platform will be used to process the transaction in accordance with the payment instrument assigned to the device 210.

It is to be appreciated that digital wallet registration could be invoked by any number of events defined by the platform. For example, registration could be invoked when a new device is added, when an existing device is reconfigured or when the user's payment setup is changed.

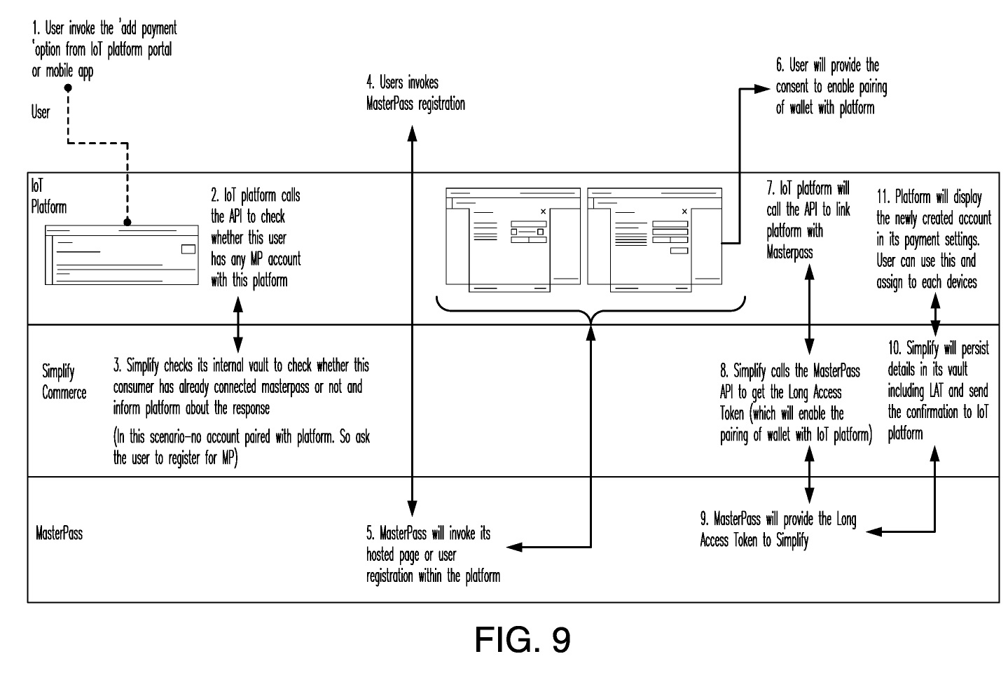

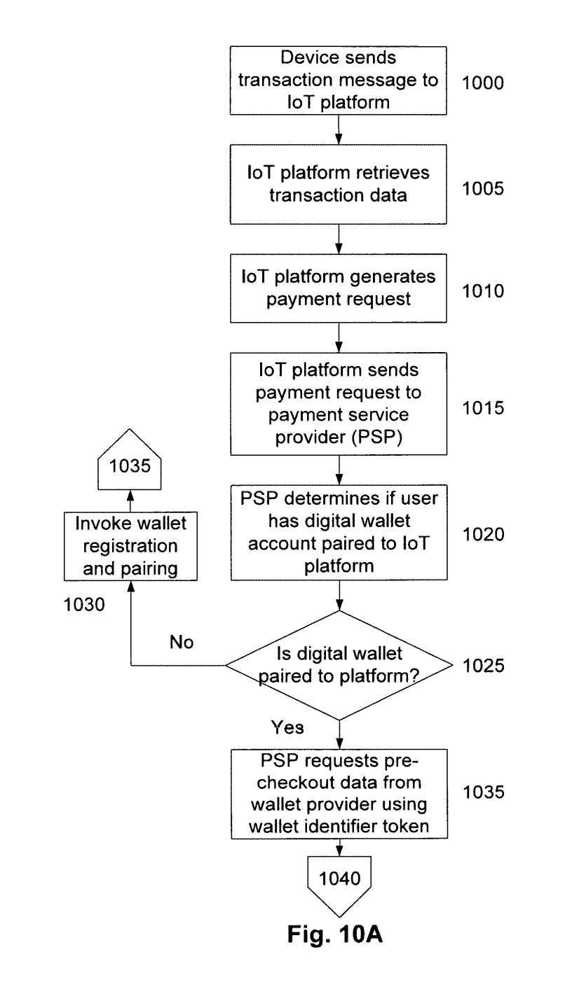

An example of suitable GUIs for use in digital wallet account registration through the IoT platform 220 are shown in FIG. 8 and in the detailed registration process flow of FIG. 9. In this example, a Masterpass wallet is used and Simplify Commerce by Mastercard is the payment service provider that is integrated with the IoT platform. As has been substantially already described, the user invokes an ‘add payment’ option from an IoT platform portal or mobile app. The IoT platform calls an API to check whether the user has a Masterpass account already paired to the platform. Simplify Commerce performs this check and informs the platform about the response. Assuming that no Masterpass account is found, the user is then asked to register for a Masterpass digital wallet. Masterpass will invoke a hosted page for user registration within the IoT platform for example as shown in FIG. 8. The user then creates a wallet account and provides consent to enable pairing between the wallet and platform. The IoT platform then calls an API to link the platform with the Masterpass wallet. Simplify commerce receives the pairing request and calls the Masterpass API to get the wallet identifier token (which will enable the pairing of wallet with IoT platform). Masterpass is responsive to provide the token to Simplify Commerce which stores the token and sends confirmation of pairing back to the IoT platform.

The IoT platform will display the new account in its payment settings thereby enabling the user to use the wallet to assign a payment instrument to each device.

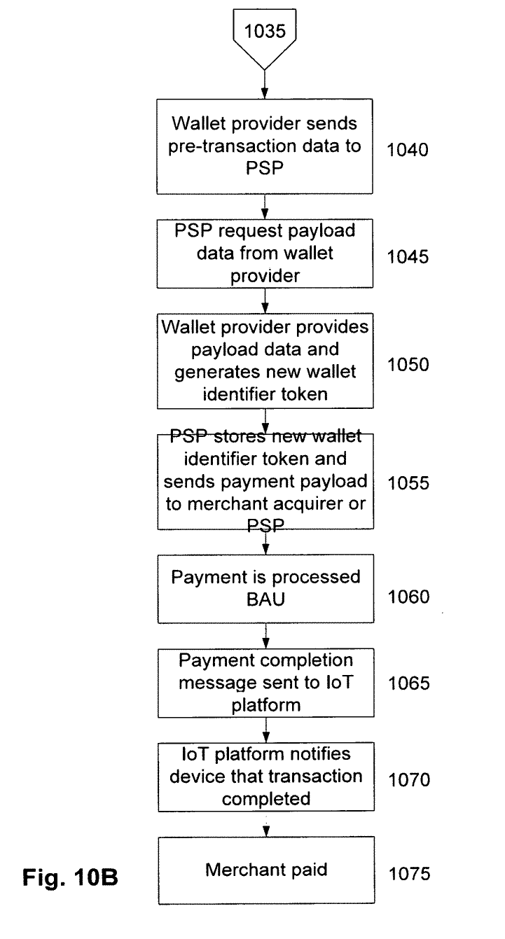

An example of a specific method of facilitating a payment transaction in an IoT system between a device and a merchant shall now be described with reference to FIGS. 10A and 10B.

In this example, at step 1000 an IoT device 210 sends a transaction message to the IoT platform 220 that is indicative of a transaction being initiated by the device 210 and which includes at least a device identifier and transaction details indicative of the transaction to be performed. At step 1005, the IoT platform 220 retrieves transaction data using the device identifier which is indicative of a user identifier and transaction rules. In this way, the IoT platform 220 is able to identifier the platform user associated with the particular device and any rules that have been setup governing the kind of transaction the device 210 is allowed to initiate. Optionally, the platform may authenticate the device 210 to ensure that it is permitted to initiate payment transactions.

At step 1010, the IoT platform generates a payment request using the transaction details and transaction rules, the payment request being indicative of the user identifier, a merchant identifier, and transaction information at least partially based on the transaction details. The payment request is sent to the payment service provider 230 by the IoT platform 220 at step 1015. The payment service provider 230 is responsive to the payment request to determine if the user has a digital wallet paired to the IoT platform 220 at step 1020. If the outcome of the check performed at step 1025 is that no wallet is paired to the platform then at step 1030 the IoT platform invokes wallet registration and pairing as previously described with reference to FIGS. 7A, 7B, 8 and 9.

If the check at step 1025 confirms that the user does already have a digital wallet paired to the IoT platform 220, then at step 1035 the payment service provider 230 requests pre-transaction data from the wallet provider 270 using the wallet identifier token stored by the payment service provider 230. At step 1040, the wallet provider 270 is responsive to send pre-transaction data to the payment service provider including for example the last three digits of the payment card, shipping id, other card information (such as reward cards) etc.

The payment service provider 230 then requests the payload data from the wallet provider 270 at step 1045. The payload data will typically include at least one of user account information, a shipping address, user data, a payment amount, a payment currency, a merchant identifier and, order information. The wallet provider 270 provides the payment payload data at step 1050 and generates a new wallet identifier token. The payment service provide 230 stores the new wallet identifier token step 1055 and send the payment payload to the merchant acquirer or payment provider so as to cause the payment to be processed. The payment is then processed business as usual (BAU) involving usual acquirer, card network, and issuer entities. At step 1065, a payment completion message is sent to the IoT platform 220 and at step 1070 the IoT platform 220 notifies the device 210 that the transaction has been completed.

After the usual settlement and funds clearing processes, the merchant is finally paid at 1075 for the goods/service involved in the transaction.

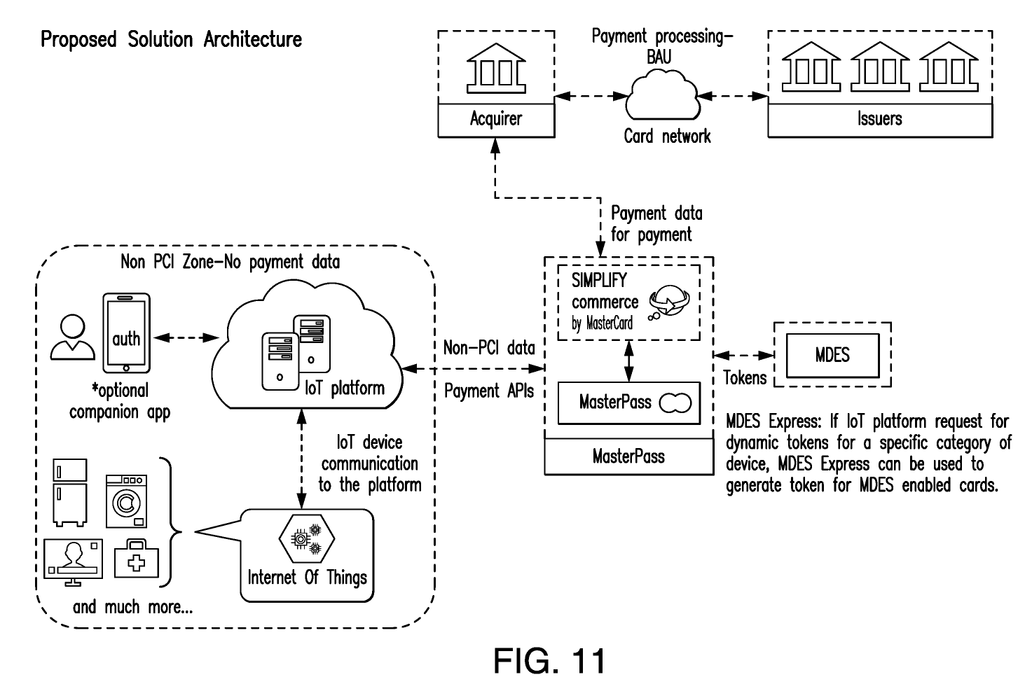

Referring now to FIG. 11 there is shown an example of a proposed solution architecture for an IoT payment system. In this example, there is shown an IoT platform in communication with one or more devices forming part of the Internet of Things. These are network connected devices able to communicate with the platform to initiate payments. A user device is also shown in communication with the platform which may for example run a companion application used in provided user authentication to device initiated transactions. The IoT platform, IoT devices and user device are located in a non-PCI zone so that no sensitive payment data is exchange with any of these entities. In this example, the IoT platform is integrated with a payment service provider, Simplify Commerce which communicates with a Masterpass digital wallet. The data exchanged between the IoT platform and Simplify Commerce is also non-PCI data and in use various payment APIs will be exposed to the platform from Simplify Commerce.

In this example, Simplify Commerce is configured to exchange payment data for payment with a payment processing system including an acquirer, card network and issuers as will be understood by those skilled in the art.

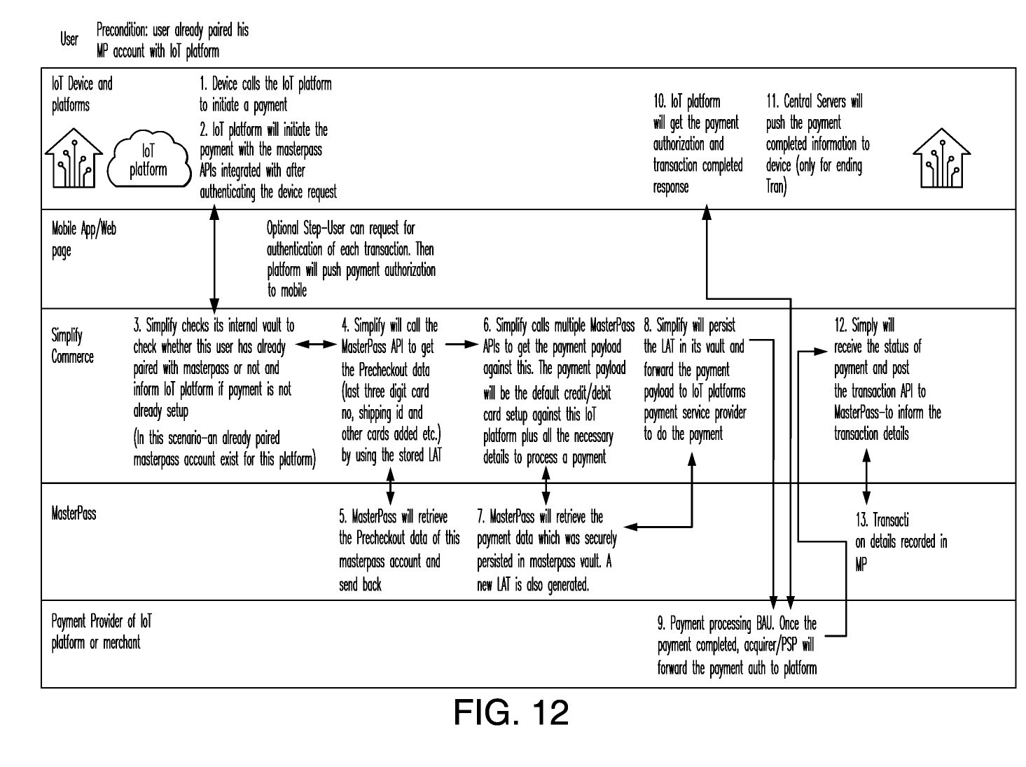

A further specific example of process flow in an IoT payment system shall now be described with reference to FIG. 12.

In this example, an IoT device calls the IoT platform to initiate a payment. The platform firstly authenticates the device request and then initiates payment through Masterpass APIs exposed to the platform. Simplify Commerce will then check whether the user has a Masterpass wallet paired to the platform. Assuming that the user does have a Masterpass account with the platform, Simplify Commerce will proceed to call the Masterpass API to obtain the pre-transaction data using the stored wallet identifier token. Masterpass then retrieves the pre-transaction data associated the user's Masterpass account and sends back to Simplify Commerce. Simplify Commerce then calls multiple Masterpass APIs to get the payment payload including for example the default credit/debit card setupt against the platform plus any further details necessary to process the payment. Masterpass will retrieve the payment data and generates a new wallet identifier token. Simplify stores the new wallet identifier token and then forwards the payment payload to the merchant's acquirer or payment provider. The payment is then processed in a standard manner between the acquirer, card network and issuer and the payment authorisation is sent to the platform. The platform then pushes a payment completion message to the device thereby notifying the device that the transaction has been processed. Simplify Commerce will receive the status of the payment and post the transaction API to Masterpass to inform the transaction details. Masterpass then records the transaction details. After the user's funds have cleared, the merchant involved in the transaction will be paid.

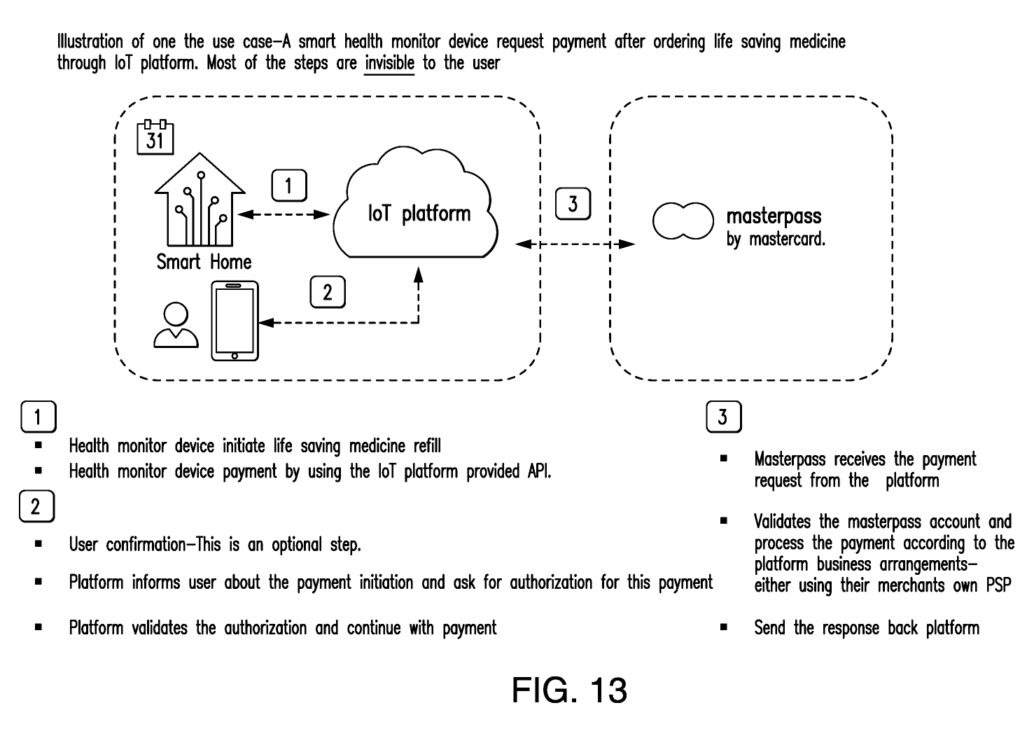

There are many applications for which the above described system and method may be useful. In FIG. 13, there is illustrated a specific use case whereby a smart health monitor requests payment after ordering life saving medicine through the IoT platform. Whilst the user may be prompted to authorise the transaction, this is optional only and typically the platform will simply send the payment request to Masterpass which then facilitates payment with a merchant so that the medicine can be delivered to the user.

It is to be appreciated that in at least one example, the above described method and system provides a secure mechanism via which IoT platforms can process payments initiated by network connected IoT devices with or without user involvement in the payment process. This enables devices to initiate payments and obtain required goods/services faster and more efficiently thereby saving the user both time and money. The system architecture described facilitates machine to machine payments in a reliable and secure manner in an IoT environment.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1) A system for managing transactions over a communications network, the system including:
a) a connected device management platform in communication with a device via a communications network; and,
b) a payment service provider, wherein, in use:
i) the connected device management platform:
(1) receives a transaction message from the device, the transaction message being indicative of:
(a) a device identifier; and,
(b) transaction details indicative of a transaction to be performed;
(2) uses the device identifier to retrieve transaction data indicative of:
(a) a user identifier; and,
(b) transaction rules;
(3) generates a payment request using the transaction details and transaction rules, the payment request being indicative of:
(a) the user identifier;
(b) a merchant identifier; and,
(c) transaction information at least partially based on the transaction details; and,
(4) provides the payment request to the payment service provider; and,
ii) the payment service provider:
(1) receives the payment request;
(2) determines a user account at least in part using the user identifier, the user account associated with user account information;
(3) determines payment details using the merchant identifier and the transaction information; and,
(4) causes the transaction to be processed using the user account information and the payment details to thereby enable the merchant to be paid in accordance with the payment details.

2) The system according to claim 1, wherein the user account is a digital wallet account that is paired to the connected device management platform.

3) The system according to claim 2, wherein the user account information is indicative of at least one payment instrument that has been assigned to the device through the connected device management platform.

4) The system according to claim 1, wherein the transaction details received from the device are indicative of at least one of:
a) a payment amount;
b) usage information; and,
c) order information.

5) The system according to claim 1, wherein the transaction rules define at least one of:
a) type of goods or service that the device is permitted to purchase;
b) frequency of orders that that the device is permitted to make;
c) quantities of goods that that the device is permitted to order;
d) pre-approved merchants that the device is permitted to use to perform transaction; and,
e) whether user authentication is required.

6) The system according to claim 1, wherein the payment details determined by the payment service provider are indicative of at least one of:
a) a payment amount;
b) merchant account information;
c) merchant acquirer information; and,
d) merchant payment service provider information.

7) The system according to claim 1, wherein the connected device management platform compares the transaction details received from the device with the transaction rules for the device to thereby authenticate the transaction message prior to generating the payment request.

8) The system according to claim 1, wherein in response to receiving the transaction message from the device, the connected device management platform:
a) generates a transaction authorization request; and,
b) sends the transaction authorization request to a user device, the user device being responsive to transaction authorization request to:
i) obtain authorization from a user; and
ii) selectively provide an authorization response to the connected device management platform;
c) receives the authorization response; and,
d) at least one of:
i) proceeds to generate the payment request; and,
ii) notifies the device that the transaction has been declined.

9) The system according to claim 2, wherein the system further includes a digital wallet provider that:
a) receives a request from the payment service provider to provide pre-transaction data associated with the user's digital wallet account, the request including a wallet identifier token which identifies the user's digital wallet account that is paired to the connected device management platform;
b) uses the wallet identifier token to retrieve the pre-transaction data; and,
c) provides the pre-transaction data to the payment service provider.

10) The system according to claim 9, wherein after receiving the pre-transaction data from the digital wallet provider, the payment service provider is responsive to request a payment payload from the digital wallet provider, the digital wallet provider being responsive to the payment payload request to:
a) retrieve the payment payload;
b) generate a new wallet identifier token; and,
c) send the payment payload and new wallet identifier token to the payment service provider.

11) The system according to claim 9, wherein the payment payload is indicative of at least one of:
a) user account information;
b) a shipping address;
c) user data;
d) a payment amount;
e) a payment currency;
f) a merchant identifier; and,
g) order information.

12) The system according to claim 10, wherein the payment service provider:
a) receives the payment payload from the digital wallet provider; and,
b) sends the payment payload to one of:
i) a merchant acquirer; and,
ii) a merchant payment provider.

13) The system according to claim 12, wherein the payment is processed in accordance with the payment payload and after successful payment authorisation, the connected device management platform receives a transaction completion response from the merchant acquirer or merchant payment provider.

14) The system according to claim 13, wherein in response to receiving the transaction completion response, the connected device management platform sends payment completion information to the device.

15) The system according to claim 9, wherein the connected device management platform, payment service provider and digital wallet provider each consist of one or more electronic processing devices.

16) A method for use in a system including a connected device management platform in communication with a device via a communications network and a payment service provider, the method including:
a) in the connected device management platform:
i) receiving a transaction message from the device, the transaction message being indicative of:
(a) a device identifier; and,
(b) transaction details indicative of a transaction to be performed;
ii) using the device identifier to retrieve transaction data indicative of:
(a) a user identifier; and,
(b) transaction rules;
iii) generating a payment request using the transaction details and transaction rules, the payment request being indicative of:
(a) the user identifier;
(b) a merchant identifier; and,
(c) transaction information at least partially based on the transaction details; and,
iv) providing the payment request to the payment service provider; and,
b) in the payment service provider:
i) receiving the payment request;
ii) determining a user account at least in part using the user identifier, the user account associated with user account information;
iii) determining payment details using the merchant identifier and the transaction information; and,
iv) causing the transaction to be processed using the user account information and the payment details to thereby enable the merchant to be paid in accordance with the payment details.

17) A system including a connected device management platform in communication with a device via a communications network, wherein the connected device management platform:
a) receives a transaction message from the device, the transaction message being indicative of:
i) a device identifier; and,
ii) transaction details indicative of a transaction to be performed;
b) uses the device identifier to retrieve transaction data indicative of:
i) a user identifier; and,
ii) transaction rules;
c) generates a payment request using the transaction details and transaction rules, the payment request being indicative of:
i) a user identifier;
ii) a merchant identifier; and,
iii) transaction information at least partially based on the transaction details;
d) provides the payment request to the payment service provider;
e) receives a transaction completion message in response to the payment service provider successfully processing the payment request; and,
f) provides an indication that the transaction has been completed to the device.
